(19) United States
(12) Patent Application Publication
(10) Pub. No.: US 2026/0036866 A1
(43) Pub. Date: Feb. 5, 2026

(54) OPTICAL WAVEGUIDE ELEMENT, OPTICAL MODULATOR, OPTICAL MODULATION MODULE, AND OPTICAL TRANSMISSION DEVICE

(71) Applicant: SUMITOMO OSAKA CEMENT CO., LTD., Tokyo (JP)

(72) Inventors: Shotaro Hirata, Tokyo (JP); Yu Kataoka, Tokyo (JP); Yuki Kugimoto, Tokyo (JP); Shingo Takano, Tokyo (JP)

(21) Appl. No.: 18/848,268

(22) PCT Filed: Mar. 30, 2022
(86) PCT No.: PCT/JP2022/016083

§ 371 Date: Apr. 9, 2025

(51) Int. Cl. G02F 1/225; G02F 1/21

(52) U.S. Cl. CPC G02F 1/225; G02F 1/212

(57) ABSTRACT

An optical waveguide device includes a substrate made of an oxide, and an optical waveguide formed on a principal surface of the substrate, in which the substrate includes an oxygen-deficient layer having a lower oxygen content than in other portions of the substrate, and the oxygen-deficient layer is disposed in a region, on the principal surface of the substrate, other than a waveguide path for light from an optical input end to an optical output end of the optical waveguide. The structure attenuates unnecessary light that propagates through the substrate while suppressing generation of substrate stress in an optical waveguide device.

### TECHNICAL FIELD

The present invention relates to an optical waveguide device, an optical modulator, an optical modulation module, and an optical transmission apparatus.

### BACKGROUND ART

In a high-frequency/large-capacity optical fiber communication system, an optical transmission apparatus incorporating a waveguide-type optical modulator is often used. In particular, an optical modulation device using LiNbO₃ (hereinafter also referred to as LN), which has an electro-optic effect, as a substrate, is widely used in the high-frequency/large-capacity optical fiber communication system because it is possible to realize broadband optical modulation characteristics with less optical loss as compared with an optical modulation device using semiconductor materials, such as indium phosphide (InP), silicon (Si), or gallium arsenide (GaAs).

Meanwhile, in a modulation method in the optical fiber communication system, in response to the trend of increasing transmission capacity in recent years, multi-level modulation or a transmission format that incorporates polarization multiplexing into multi-level modulation, such as quadrature phase shift keying (QPSK) and dual polarization-quadrature phase shift keying (DP-QPSK), has become mainstream.

Acceleration in the spread of the Internet services in recent years has led to a further increase in communication traffic, and studies are still underway to further reduce the size, broaden the bandwidth, and reduce the power consumption of the optical modulation device.

As one measure to reduce the size, broaden the bandwidth, and reduce the power consumption of such an optical modulation device, an optical modulator using a rib optical waveguide or a ridge optical waveguide (hereinafter collectively referred to as a protruding optical waveguide) having a band-shaped protruding portion formed on a surface of an LN substrate (for example, a thickness of 20 μm or less) thinned in order to enhance the interaction between a signal electric field and guided light in the substrate (that is, in order to increase the electric field efficiency), or a diffused waveguide formed by Ti diffusion is also being put to practical use.

In a case where the substrate is, for example, thinned to have a thickness of about several μm or less in order to further increase the electric field efficiency, a new issue may arise. That is, in the optical waveguide device such as the optical modulation device using the optical waveguide formed on the substrate, generally, an optical coupling section between an optical fiber for light input and the optical waveguide, a light branching section such as a Y-branched waveguide, and/or a curved waveguide section in which an optical propagation direction, light that propagates through the optical waveguide may leak into the substrate and become unnecessary light (for example, so-called off light or stray light). The unnecessary light may be guided inside the substrate and then again coupled to the optical waveguide to become noise light, and, for example, an extinction ratio of an optical modulation waveform may be reduced in the optical modulation device.

As a configuration for suppressing the propagation of the unnecessary light through the substrate, Patent Literature 1 discloses an optical waveguide device in which a conductive layer made of gold (Au) is provided on a surface of a portion of a substrate through which unnecessary light propagates, via an underlayer made of titanium (Ti). In this optical waveguide device, the propagation of the unnecessary light that propagates through the substrate is suppressed by the optical electric field absorption of a Ti metal.

### CITATION LIST

### Patent Literature

[Patent Literature No. 1] Japanese Patent Application No. 2021-089824

### SUMMARY OF INVENTION

### Technical Problem

However, in the related art, stress is accumulated in the substrate as an environmental temperature fluctuates, due to a difference in a linear expansion coefficient between the underlayer made of Ti and the substrate. The accumulation of the stress in the substrate may be a factor in mechanical deformation such as warpage in the substrate, and may also be a factor in a characteristic variation such as DC drift in a case of an optical waveguide device using an LN substrate.

The present invention is to effectively attenuate and remove unnecessary light that propagates through a substrate while suppressing generation of substrate stress in an optical waveguide device.

### Solution to Problem

An aspect of the present invention provides an optical waveguide device including: a substrate made of an oxide; and an optical waveguide formed on a principal surface of the substrate, in which the substrate includes an oxygen-deficient layer having a lower oxygen content than in other portions of the substrate, and the oxygen-deficient layer is disposed in a region, on the principal surface of the substrate, other than a waveguide path for light from an optical input end to an optical output end of the optical waveguide.

In another aspect of the present invention, the oxygen-deficient layer is disposed in a surface layer of the principal surface of the substrate.

In still another aspect of the present invention, the optical waveguide is a rib optical waveguide including a rib portion as a protruding portion of the substrate, which extends on the principal surface, and a slab portion having a smaller thickness of the substrate than in the rib portion, and the oxygen-deficient layer is disposed on a side surface and/or an upper surface of the rib portion in the optical waveguide other than the waveguide path.

In still another aspect of the present invention, in a cross section of the rib portion perpendicular to a length direction of the optical waveguide, a ratio of a sum of lengths of an upper side and two lateral sides of the cross section of the rib portion to a sum of lengths of the upper side and/or the lateral sides on which the oxygen-deficient layer is formed is 18% or more.

In still another aspect of the present invention, the optical waveguide is a rib optical waveguide including a rib portion as a protruding portion of the substrate, which extends on the principal surface, and a slab portion having a smaller thickness of the substrate than in the rib portion, and the oxygen-deficient layer is disposed on an upper surface of the slab portion.

In still another aspect of the present invention, the substrate has a thickness of 2 μm or less.

In still another aspect of the present invention, the substrate has an electro-optic effect.

Still another aspect of the present invention provides an optical modulator including: the optical waveguide device as an optical modulation device, including a modulation electrode that modulates a light wave that propagates through the optical waveguide on the principal surface of the substrate and performing optical modulation; a case that accommodates the optical waveguide device; an optical fiber through which light is input to the optical waveguide device; and an optical fiber that guides the light output by the optical waveguide device to an outside of the case.

Still another aspect of the present invention provides an optical modulation module including: the optical waveguide device as an optical modulation device, including a modulation electrode that modulates a light wave that propagates through the optical waveguide on the principal surface of the substrate and performing optical modulation; a case that accommodates the optical waveguide device; an optical fiber through which light is input to the optical waveguide device; an optical fiber that guides the light output by the optical waveguide device to an outside of the case; and a drive circuit that outputs an electrical signal to be input to the modulation electrode.

Still another aspect of the present invention provides an optical transmission apparatus including: the optical modulator or the optical modulation module; and an electronic circuit that generates an electrical signal for causing the optical waveguide device to perform an optical modulation operation.

### Advantageous Effects of Invention

According to the present invention, it is possible to effectively attenuate and remove the unnecessary light that propagates through the substrate while suppressing the generation of the substrate stress.

### BRIEF DESCRIPTION OF DRAWINGS

FIG. 1 is a view showing a configuration of an optical waveguide device according to a first embodiment of the present invention.

FIG. 2 is a partial detailed view of a part A of the optical waveguide device shown in FIG. 1.

FIG. 3 is a cross-sectional view of the part A of the optical waveguide device shown in FIG. 2, which is taken along a line III-III.

FIG. 4 is a cross-sectional view of the part A of the optical waveguide device shown in FIG. 2, which is taken along a line IV-IV.

FIG. 5 is a cross-sectional view of the optical waveguide device shown in FIG. 1, which is taken along a line V-V.

FIG. 6 is a cross-sectional view of the optical waveguide device shown in FIG. 1, which is taken along a line VI-VI.

FIG. 7 is a cross-sectional view of the part A of the optical waveguide device shown in FIG. 2, which is taken along a line VII-VII.

FIG. 8 is a cross-sectional view of an optical waveguide device according to a modification example, which is taken along the line III-III.

FIG. 9 is a cross-sectional view of an optical waveguide device according to the modification example, which is taken along the line IV-IV.

FIG. 10 is a cross-sectional view of an optical waveguide device according to the modification example, which is taken along the line VI-VI.

FIG. 11 is a cross-sectional view of an optical waveguide device according to the modification example, which is taken along a line VII-VII.

FIG. 12 is a cross-sectional view of an evaluation sample used for evaluating a light attenuation effect of an oxygen-deficient layer.

FIG. 13 is a view showing evaluation results of the light attenuation effect of the oxygen-deficient layer.

FIG. 14 is a view showing a configuration of an optical modulator according to a second embodiment of the present invention.

FIG. 15 is a view showing a configuration of an optical modulation module according to a third embodiment of the present invention.

FIG. 16 is a view showing a configuration of an optical transmission apparatus according to a fourth embodiment of the present invention.

### DESCRIPTION OF EMBODIMENTS

Hereinafter, embodiments of the present invention will be described with reference to the accompanying drawings.

### First Embodiment

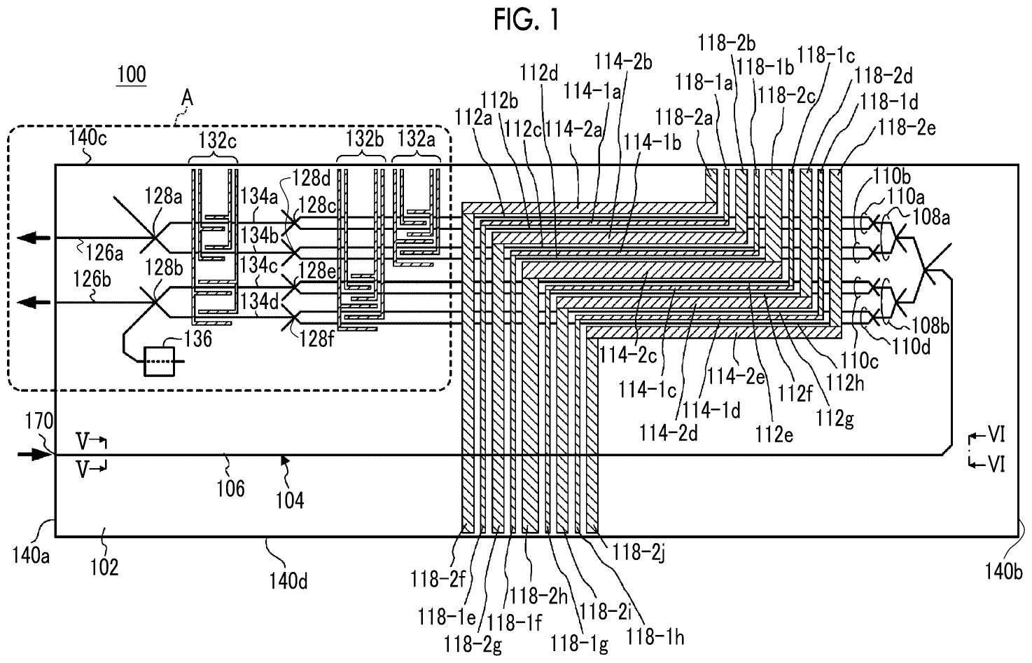

FIG. 1 is a view showing a configuration of an optical waveguide device 100 according to a first embodiment of the present invention. The optical waveguide device 100 includes a substrate 102, and an optical waveguide 104 formed on a principal surface (surface shown in FIG. 1) of the substrate 102. The substrate 102 is a substrate made of an oxide. In the present embodiment, the substrate 102 is an X-cut LN substrate made of LiNbO₃, which is the oxide. The substrate 102 is, for example, treated and thinned to have a thickness of 2 μm or less. The optical waveguide 104 is a rib optical waveguide configured as a protruding portion extending in a strip shape and formed on the principal surface of the thinned substrate 102. That is, the optical waveguide 104 includes a rib portion as the protruding portion of the substrate 102 extending on the principal surface of the substrate 102, and a slab portion having a smaller thickness of the substrate 102 than in the rib portion.

The substrate 102 is, for example, rectangular and has two sides 140a and 140b that are on left and right sides in the drawing, that extend in an up-down direction in the drawing, and that face each other, and sides 140c and 140d that are on upper and lower sides in the drawing, that extend in a left-right direction in the drawing, and that face each other.

In the present embodiment, the optical waveguide device 100 is an optical modulation device including a modulation electrode that modulates a light wave that propagates through the optical waveguide 104 on the principal surface of the substrate 102 and performing optical modulation. Specifically, the optical waveguide device 100 constitutes a DP-QPSK optical modulator using two nested Mach-Zehnder optical waveguides 108a and 108b. The nested Mach-Zehnder optical waveguide 108a includes two Mach-Zehnder optical waveguides 110a and 110b. The nested Mach-Zehnder optical waveguide 108b includes two Mach-Zehnder optical waveguides 110c and 110d.

The Mach-Zehnder optical waveguides 110a and 110b include two parallel waveguides 112a and 112b and two parallel waveguides 112c and 112d, respectively. Further, the Mach-Zehnder optical waveguides 110c and 110d include two parallel waveguides 112e and 112f and two parallel waveguides 112g and 112h, respectively.

The input light (arrow pointing rightward in the drawing) input to an input waveguide 106 of the optical waveguide 104 on the lower side of the side 140a in the drawing, which is on the left side of the substrate 102 in the drawing, is folded back by 180 degrees in an optical propagation direction and is branched into two light beams, and the two light beams are QPSK-modulated by the two nested Mach-Zehnder optical waveguides 108a and 108b, respectively. The two QPSK-modulated light beams are output from an upper side of the side 140a in the drawing, which is on the left side of the substrate 102 in the drawing, via output waveguides 126a and 126b, respectively (two arrows pointing to leftward in the drawing). Here, an end portion of the input waveguide 106 to which the light is input is an optical input end 170 of the optical waveguide 104, and end portions of the output waveguides 126a and 126b from which the light is output are optical output ends 172a and 172b of the optical waveguide 104. Hereinafter, the optical output ends 172a and 172b are also collectively referred to as an optical output end 172.

These two output light beams are output from the substrate 102 and then polarized and combined into one light beam by, for example, a polarization beam combiner, and the light beam is transmitted to a transmission optical fiber as a DP-QPSK-modulated optical signal.

For the QPSK modulation in the nested Mach-Zehnder optical waveguide 108a, signal electrodes 114-1a and 114-1b to which high-frequency electrical signals for modulation are input are disposed between the two parallel waveguides 112a and 112b of the Mach-Zehnder optical waveguide 110a and between the two parallel waveguides 112c and 112d of the Mach-Zehnder optical waveguide 110b, respectively.

Further, for the QPSK modulation in the nested Mach-Zehnder optical waveguide 108b, signal electrodes 114-1c and 114-1d to which high-frequency electrical signals for modulation are input are disposed between the two parallel waveguides 112e and 112f of the Mach-Zehnder optical waveguide 110c and between the two parallel waveguides 112g and 112h of the Mach-Zehnder optical waveguide 110d, respectively.

The signal electrode 114-1a constitutes a coplanar transmission line together with ground electrodes 114-2a and 114-2b facing each other with the parallel waveguides 112a and 112b interposed therebetween, and the signal electrode 114-1b constitutes a coplanar transmission line together with ground electrodes 114-2b and 114-2c facing each other with the parallel waveguides 112c and 112d interposed therebetween.

The signal electrode 114-1c constitutes a coplanar transmission line together with ground electrodes 114-2c and 114-2d facing each other with the parallel waveguides 112e and 112f interposed therebetween, and the signal electrode 114-1d constitutes a coplanar transmission line together with ground electrodes 114-2d and 114-2e facing each other with the parallel waveguides 112e and 112f interposed therebetween.

Hereinafter, the nested Mach-Zehnder optical waveguides 108a and 108b are also collectively referred to as a nested Mach-Zehnder optical waveguide 108. Further, the Mach-Zehnder optical waveguides 110a, 110b, 110c, 110d, 110e, 110f, 110g, and 110h are also collectively referred to as a Mach-Zehnder optical waveguide 110. Further, the parallel waveguides 112a, 112b, 112c, 112d, 112e, 112f, 112g, 112h are also collectively referred to as a parallel waveguide 112. Further, the signal electrodes 114-1a, 114-1b, 114-1c, and 114-1d are also collectively referred to as a signal electrode 114-1. Further, the ground electrodes 114-2a, 114-2b, 114-2c, 114-2d, and 114-2e are also collectively referred to as a ground electrode 114-2.

Further, the signal electrode 114-1 and the ground electrode 114-2 are collectively referred to as a working electrode 114. The signal electrode 114-1 and the ground electrode 114-2, which are the working electrodes 114, control the light wave that propagates through the optical waveguide 104. Further, the signal electrode 114-1 and the ground electrode 114-2 are two working electrodes 114 that interpose the parallel waveguide 112 of the optical waveguide 104 in a plane of the substrate 102. The working electrode 114 corresponds to a modulation electrode in the present disclosure.

The right end portions of the signal electrodes 114-1a, 114-1b, 114-1c, and 114-1d in the drawing are connected to signal wiring electrodes 118-1a, 118-1b, 118-1c, and 118-1d, respectively. Further, the left end portions of the signal electrodes 114-1a, 114-1b, 114-1c, and 114-1d in the drawing are connected to signal wiring electrodes 118-1e, 118-1f, 118-1g, and 118-1h, respectively.

The right ends of the ground electrodes 114-2a, 114-2b, 114-2c, 114-2d, and 114-2e in the drawing are connected to ground wiring electrodes 118-2a, 118-2b, 118-2c, 118-2d, and 118-2e, respectively. Therefore, the signal wiring electrodes 118-1a, 118-1b, 118-1c, and 118-1d and the ground wiring electrodes 118-2a, 118-2b, 118-2c, 118-2d, and 118-2e adjacent to these signal wiring electrodes constitute the coplanar transmission line.

In the same manner, the left ends of the ground electrodes 114-2a, 114-2b, 114-2c, 114-2d, and 114-2e in the drawing are connected to ground wiring electrodes 118-2f, 118-2g, 118-2h, 118-2i, and 118-2j, respectively. Therefore, the signal wiring electrodes 118-1e, 118-1f, 118-1g, and 118-1h and the ground wiring electrodes 118-2f, 118-2g, 118-2h, 118-2i, and 118-2j adjacent to these signal wiring electrodes constitute the coplanar transmission line.

The signal wiring electrodes 118-1e, 118-1f, 118-1g, and 118-1h extending to the lower side 140d of the substrate 102 in the drawing are terminated by a termination resistor having a predetermined impedance outside the substrate 102.

Therefore, the high-frequency electrical signals input from the signal wiring electrodes 118-1a, 118-1b, 118-1c, and 118-1d extending to the upper side 140c of the substrate 102 in the drawing become traveling waves to propagate through the signal electrodes 114-1a, 114-1b, 114-1c, and 114-1d, and modulate the light waves that propagates through the Mach-Zehnder optical waveguides 110a, 110b, 110c, and 110d, respectively.

Hereinafter, the signal wiring electrodes 118-1a, 118-1b, 118-1c, 118-1d, 118-1e, 118-1f, 118-1g, and 118-1h are also collectively referred to as a signal wiring electrode 118-1. Further, the ground wiring electrodes 118-2a, 118-2b, 118-2c, 118-2d, 118-2e, 118-2f, 118-2g, 118-2h, 118-2i, and 118-2j are also collectively referred to as a ground wiring electrode 118-2. Further, the signal wiring electrode 118-1 and the ground wiring electrode 118-2 are also collectively referred to as a wiring electrode 118. That is, the signal wiring electrode 118-1 and the ground wiring electrode 118-2 are the wiring electrodes 118 connected to the working electrode 114.

The substrate 102 is also provided with a bias electrode 132a for adjusting a bias point of the Mach-Zehnder optical waveguides 110a and 110b, a bias electrode 132b for adjusting a bias point of the Mach-Zehnder optical waveguides 110c and 110d, and a bias electrode 132c for adjusting a bias point of the nested Mach-Zehnder optical waveguides 108a and 108b.

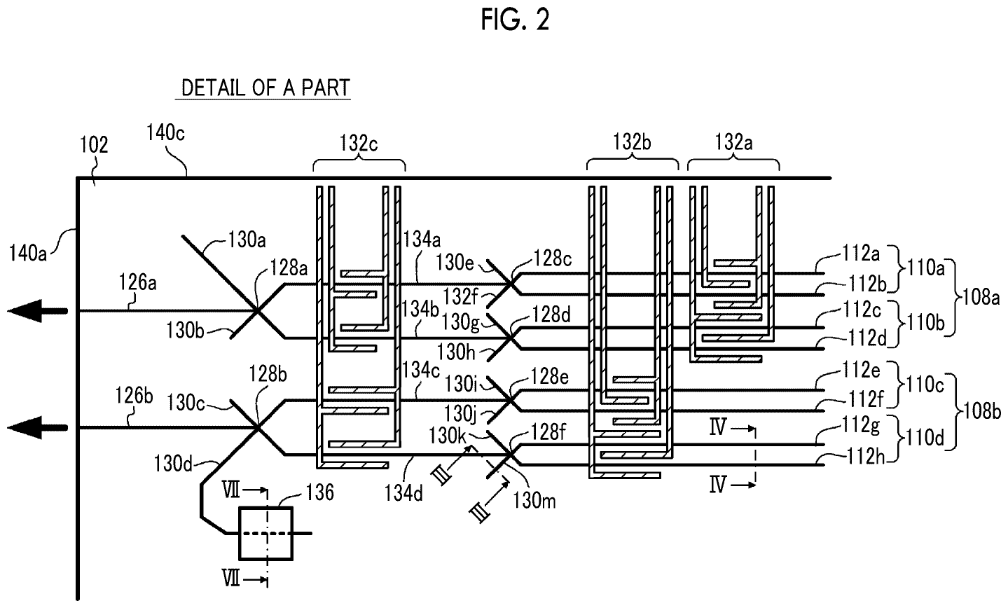

FIG. 2 is a partial detailed view of a part A shown in FIG. 1.

Two radiated light beam waveguides 130a and 130b and two radiated light beam waveguides 130c and 130d through which the radiated light beams, which leak from the nested Mach-Zehnder optical waveguides 108a and 108b without being combined, propagate are provided in the Y-branch couplers 128a and 128b connected to the output waveguides 126a and 126b of the nested Mach-Zehnder optical waveguides 108a and 108b, respectively. In the same manner, two radiated light beam waveguides 130e and 130f and two radiated light beam waveguides 130g and 130h are provided in the Y-branch couplers 128c and 128d of the Mach-Zehnder optical waveguides 110a and 110b connected to the parallel waveguides 134a and 134b of the nested Mach-Zehnder optical waveguide 108a, respectively.

In addition, two radiated light beam waveguides 130i and 130j and two radiated light beam waveguides 130k and 130m are provided in the Y-branch couplers 128e and 128f of the Mach-Zehnder optical waveguides 110c and 110d connected to the parallel waveguides 134c and 134d of the nested Mach-Zehnder optical waveguide 108b, respectively. The configuration and the function of the radiated light beam waveguide are disclosed in, for example, Japanese Patent No. 4745432. Hereinafter, the Y-branch couplers 128a, 128b, 128c, 128d, 128e, and 128f are also collectively referred to as a Y-branch coupler 128. In addition, the radiated light beam waveguides 130a, 130b, 130c, 130d, 130e, 130f, 130g, 130h, 130i, 130j, 130k, and 130m are also collectively referred to as a radiated light beam waveguide 130.

The radiated light beam waveguide 130d is used as a monitor optical waveguide, and a light-receiving element 136 is disposed on an upper portion of a part of the radiated light beam waveguide 130d.

The radiated light beam waveguide 130 may be formed not only in the Y-branch coupler 128 but also in a light branching section in the optical waveguide 104 shown on the right side in the drawing of FIG. 1 in the same manner.

In the present embodiment, particularly, an oxygen-deficient layer 200 (to be described later) is disposed in a region, on the principal surface of the substrate 102, other than a waveguide path for light from the optical input end 170 to the optical output end 172 of the optical waveguide 104. A portion of the oxygen-deficient layer 200 has a lower oxygen content of the oxide constituting the substrate 102 than in the other portions of the substrate 102. For example, the oxygen-deficient layer 200 is disposed on a surface layer of the principal surface of the substrate 102. The oxygen-deficient layer 200 may be formed, for example, by treating the surface of the substrate 102 made of the oxide, via dry etching based on the related art.

Since the decrease in oxygen content leads to the increase in the optical absorption loss in the oxide substrate (for example, see Japanese Laid-open Patent Publication No. 2015-14716), the oxygen-deficient layer 200 has a higher optical absorption loss compared to other portions. As a result, the unnecessary light that propagates through a lower portion of the oxygen-deficient layer 200 is absorbed by the oxygen-deficient layer 200 and is effectively attenuated.

As will be described later, in the present embodiment, the oxygen-deficient layer 200 is disposed, for example, on a side surface and/or an upper surface of the rib portion 144 in the radiated light beam waveguide 130 that is an optical waveguide other than the waveguide path from the optical input end 170 to the optical output end 172 of the optical waveguide 104. Alternatively, the oxygen-deficient layer 200 is, for example, disposed on an upper surface of the slab portion 145.

Hereinafter, an example of the portion of the substrate 102 in which the oxygen-deficient layer 200 is formed will be described.

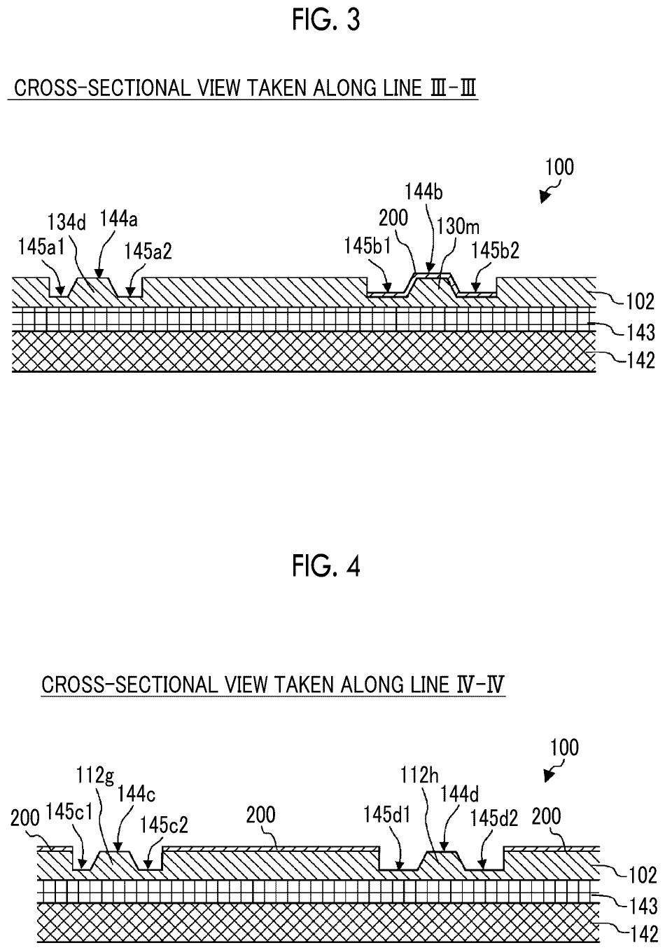

FIG. 3 is a cross-sectional view of the optical waveguide device 100 shown in FIG. 2, which is taken along a line III-III, and is a view showing a cross section of the substrate 102 at the parallel waveguide 134d of the nested Mach-Zehnder optical waveguide 108b and the radiated light beam waveguide 130m.

A back surface (lower surface in the drawing) of the substrate 102 is supported and reinforced by a supporting plate 142 via an adhesive layer 143. The supporting plate 142 is, for example, glass. The parallel waveguide 134d includes a rib portion 144a interposed between slab portions 145a1 and 145a2. In addition, the radiated light beam waveguide 130m includes a rib portion 144b interposed between slab portions 145b1 and 145b2. Hereinafter, the protruding portion on the substrate 102 that constitute the optical waveguide 104, including the rib portions 144a and 144b, are also collectively referred to as a rib portion 144. In addition, a flat plate portion including the slab portions 145a1, 145a2, 145b1, and 145b2 and formed to be thinner than the rib portion 144 with the rib portion 144 interposed therebetween, including the slab portions, is also referred to as the slab portion 145.

In FIG. 3, in particular, the oxygen-deficient layer 200 having a larger light absorption coefficient larger than in other portions of the substrate 102 is formed on the upper surface and both left and right side surfaces of the rib portion 144b in the drawing constituting the radiated light beam waveguide 130m. Therefore, the unnecessary light that propagates through the radiated light beam waveguide 130m is absorbed by the oxygen-deficientlayer 200, and is effectively attenuated and removed.

In the present embodiment, as shown in FIG. 3, the oxygen-deficient layer 200 is also formed to extend in the slab portions 145b1 and 145b2 that interpose the rib portion 144b of the radiated light beam waveguide 130m. Therefore, the unnecessary light leaking from the radiated light beam waveguide 130m to the slab portions 145b1 and 145b2 is also absorbed by the oxygen-deficient layer 200, and is effectively attenuated and removed.

The example of FIG. 3 shows the configuration in which the oxygen-deficient layer 200 is disposed on the upper surface and both side surfaces of the radiated light beam waveguide 130m, but the oxygen-deficient layer 200 can be similarly disposed in a surface layer of the radiated light beam waveguide 130 other than the radiated light beam waveguide 130m. Accordingly, the unnecessary light can be effectively attenuated and removed in each radiated light beam waveguide 130.

In addition, in the example of FIG. 3, the oxygen-deficient layer 200 is disposed on the upper surface and both side surfaces of the radiated light beam waveguide 130m. However, even in a case where the oxygen-deficient layer 200 is formed on all or a part of the upper surface or the side surface of the radiated light beam waveguide 130, the same effect of unnecessary light removal as described above can be obtained.

FIG. 4 is a cross-sectional view taken along a line IV-IV in FIG. 2, and is a view showing a cross section of the substrate 102 at the two parallel waveguides 112g and 112h of the Mach-Zehnder optical waveguide 110d.

The parallel waveguide 112g includes a rib portion 144c interposed between slab portions 145c1 and 145c2. In the same manner, the parallel waveguide 112h includes a rib portion 144d interposed between slab portions 145d1 and 145d2.

In the present embodiment, in particular, the oxygen-deficient layer 200 is formed on the upper portion of the substrate 102 through which the radiated light beam (off light or stray light) as the unnecessary light can propagate, other than the rib portion 144 and the slab portion 145 constituting the parallel waveguides 112g and 112h through which the signal light propagates. Accordingly, the unnecessary light that propagates through the substrate 102 is effectively attenuated and removed.

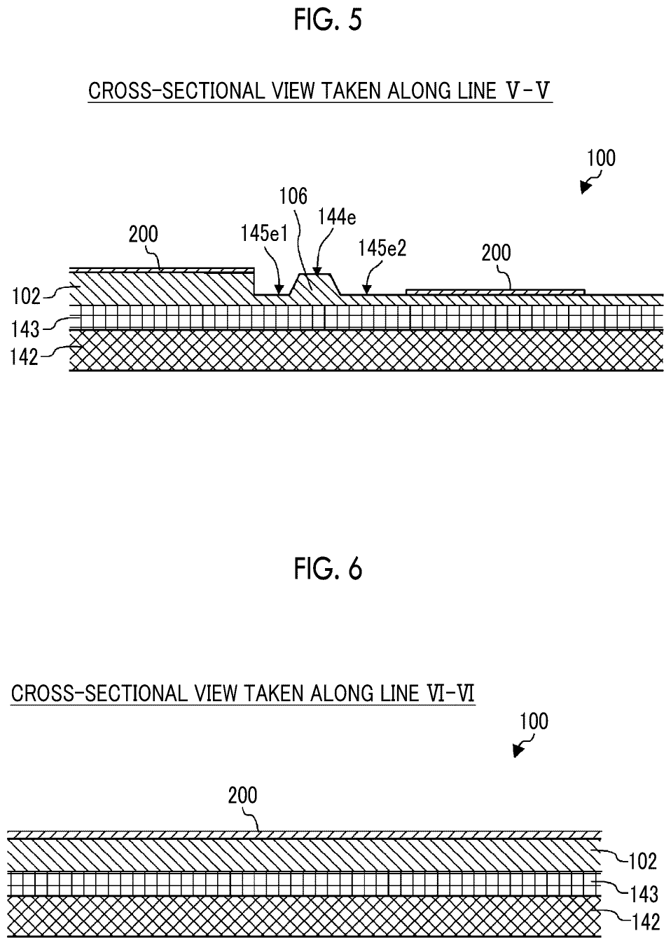

FIG. 5 is a cross-sectional view taken along a line V-V in FIG. 1, and is a view showing a cross section of the substrate 102 in the input waveguide 106.

The input waveguide 106 includes a rib portion 144e interposed between slab portions 145e1 and 145e2. A slab portion 145e on the right side of the rib portion 144e in the drawing extends in the right direction in the drawing on the substrate 102.

The oxygen-deficient layer 200 is formed on an upper surface of the substrate 102 extending to the left side of the rib portion 144e in the drawing with the slab portion 145e1 interposed therebetween. Accordingly, the unnecessary light that propagates through the substrate 102 on the left side of the rib portion 144e in the drawing is removed.

In addition, the oxygen-deficient layer 200 is formed spaced away from the rib portion 144, on the upper portion of the slab portion 145e2 on the right side of the rib portion 144e in the drawing. Accordingly, the unnecessary light that propagates through the portion of the substrate 102 in which the slab portion 145e2 is formed is removed. In particular, the rib portion 144e has a smaller thickness of the substrate 102 than in a portion, in which the oxygen-deficient layer 200 is formed, in the left portion of the rib portion 144e in the drawing, and thus the propagation of the unnecessary light is more effectively suppressed than in the left portion. In the configuration of FIG. 5, the oxygen-deficient layer 200 is provided in the slab portion 145e2 in which the propagation of the unnecessary light is suppressed due to the thin thickness of the substrate 102, and thus the unnecessary light is more effectively removed than in the left portion. In addition, since the oxygen-deficient layer 200 in the slab portion 145e2 is formed spaced away from the rib portion 144e, the oxygen-deficient layer 200 does not cause a loss in the signal light that propagates through the input waveguide 106 including the rib portion 144e.

FIG. 6 is a cross-sectional view taken along a line VI-VI in FIG. 1, and is a view showing a cross section of a portion of the substrate 102 in which the optical waveguide 104 is not formed.

The oxygen-deficient layer 200 is formed on the upper surface of the substrate 102 (that is, the surface layer of the principal surface of the substrate 102). Accordingly, the unnecessary light that propagates through the substrate 102 in which the optical waveguide 104 is not formed is also removed by the oxygen-deficient layer 200.

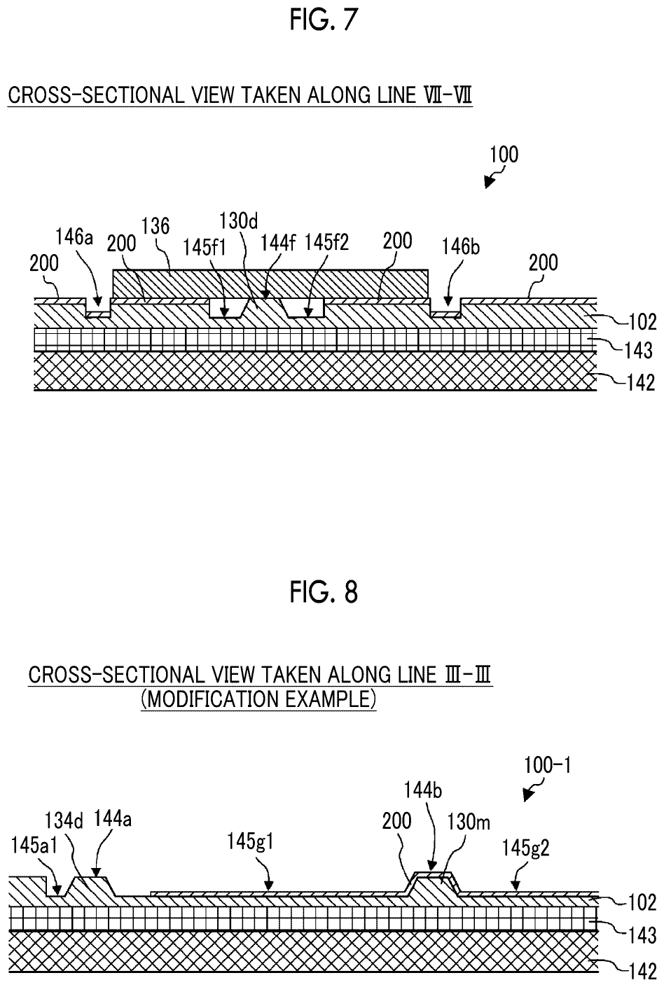

FIG. 7 is a cross-sectional view taken along a line VII-VII in FIG. 2, and is a view showing a cross section of a portion of the substrate 102 in which the light-receiving element 136 is disposed on the radiated light beam waveguide 130d.

The radiated light beam waveguide 130d includes a rib portion 144f interposed between slab portions 145f1 and 145f2. The light-receiving element 136 is disposed in the upper portion of the rib portion 144f in close proximity to the upper surface of the rib portion 144f, between two markers 146a and 146b that are recess portions provided in the substrate 102. In this manner, the light-receiving element 136 monitors the light wave that propagates through the radiated light beam waveguide 130d, thereby indirectly monitoring, for example, the light quantity of the output signal light that propagates through the output waveguide 126b.

The oxygen-deficient layer 200 is formed on the upper surface of the portion of the substrate 102 excluding the rib portion 144f and the slab portions 145f1 and 145f2. Accordingly, the unnecessary light that propagates through the portion of the substrate 102 around the radiated light beam waveguide 130d is attenuated and removed.

In the optical waveguide device 100 having the above-described configuration, the oxygen-deficient layer 200 having a lower oxygen content of the oxide constituting the substrate 102 than in other portions of the substrate 102 is disposed in a region other than the waveguide path for light from the optical input end 170 to the optical output end 172 of the optical waveguide 104. The oxygen-deficient layer 200 is obtained by, for example, treating the surface layer of the substrate 102 via dry etching, and does not cause the accumulation of the stress in the substrate 102 as compared to the related-art configuration in which a metal such as Ti is formed on the upper surface of the substrate 102. Therefore, in the optical waveguide device 100, the unnecessary light that propagates through the substrate 102 can be effectively attenuated and removed while suppressing the generation of the stress in the substrate 102.

From the viewpoint of reducing the unnecessary light that propagates through the substrate 102, it is desirable to provide a region for forming the slab portion 145, which has a small thickness of the substrate 102 and the unnecessary light is less likely to propagate, as widely as possible.

FIGS. 8 to 11 are views showing a cross-sectional configuration of an optical waveguide device 100-1 according to a modification example of the optical waveguide device 100, which is formed by expanding the region for forming of the slab portion 145. Since a planar configuration of the optical waveguide device 100-1 is the same as the planar configuration of the optical waveguide device 100 shown in FIGS. 1 and 2, the description of FIGS. 1 and 2 is incorporated herein by reference. In FIGS. 8 to 11, the same components as the components in FIGS. 3, 4, 6, and 7 are denoted by the same reference numerals as the reference numerals in FIGS. 8 to 11, and the description of FIGS. 8 to 11 is incorporated herein by reference.

FIG. 8 is a cross-sectional view of the optical waveguide device 100-1 corresponding to the cross-sectional view of the optical waveguide device 100 shown in FIG. 3, which is taken along the line III-III. The optical waveguide device 100-1 shown in FIG. 8 has the same configuration as the configuration of the optical waveguide device 100 shown in FIG. 3, but a portion between the parallel waveguide 134d and the radiated light beam waveguide 130m includes one slab portion 145g1 instead of the slab portions 145a2 and 145b1. In addition, the optical waveguide device 100-1 shown in FIG. 8 includes a slab portion 145g2 extending to the right side in the drawing instead of the slab portion 145b2 shown in FIG. 3.

The oxygen-deficient layer 200 is formed on the upper surfaces of the slab portion 145g1 and the slab portion 145g2, as well as on the upper surface and the side surface of the rib portion 144b.

In this manner, in the configuration of the optical waveguide device 100-1 shown in FIG. 8, the unnecessary light leaking from the radiated light beam waveguide 130m is more effectively removed by the slab portions 145g1 and 145g2 in which the oxygen-deficient layer 200 is formed than in the configuration shown in FIG. 3.

In FIG. 8, the oxygen-deficient layer 200 formed on the slab portion 145g1 is formed spaced away from the rib portion 144a of the parallel waveguide 134d through which the signal light propagates. Therefore, the oxygen-deficient layer 200 does not cause a loss in the signal light that propagates through the parallel waveguide 134d.

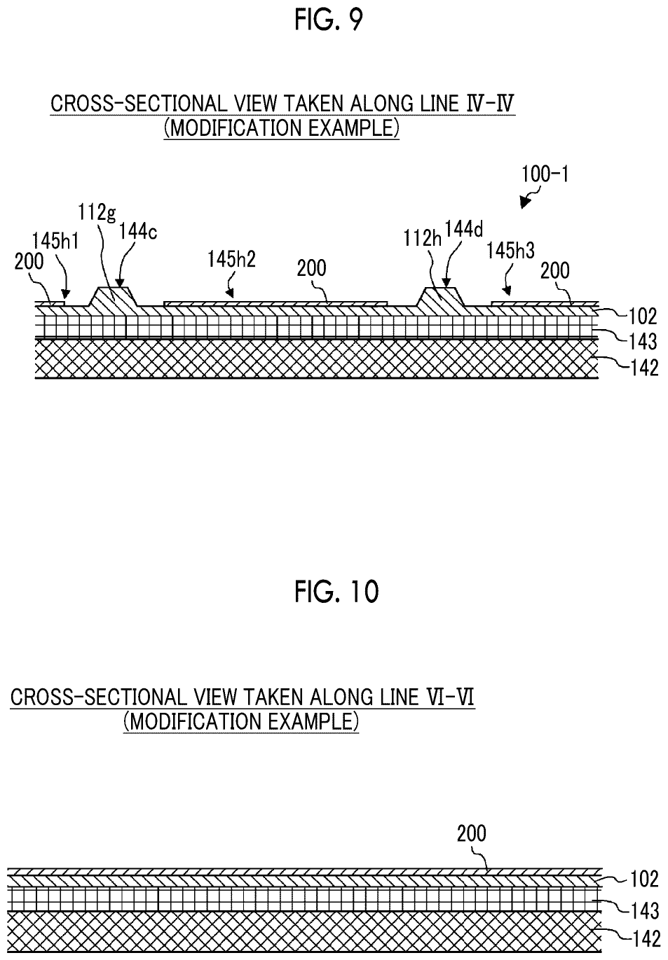

FIG. 9 is a cross-sectional view of the optical waveguide device 100-1 corresponding to the cross-sectional view of the optical waveguide device 100 shown in FIG. 4, which is taken along the line IV-IV.

The optical waveguide device 100-1 shown in FIG. 9 has the same configuration as the configuration of the optical waveguide device 100 shown in FIG. 4, but a portion between the parallel waveguide 112g and the parallel waveguide 112g includes one slab portion 145h2 instead of the slab portions 145c2 and 145d1. In addition, the optical waveguide device 100-1 shown in FIG. 9 includes slab portions 145h1 and 145h3 that further extend to the left and right sides in the drawing, respectively, instead of the slab portions 145c1 and 145d2 shown in FIG. 3.

The oxygen-deficient layer 200 is formed spaced away from the rib portions 144c and 144d, on each of the upper surfaces of the slab portions 145h1, 145h2, and 145h3. In this manner, in the configuration of the optical waveguide device 100-1 shown in FIG. 9, the unnecessary light that propagates through the substrate 102 around the parallel waveguides 112g and 112h can be more effectively removed than in the optical waveguide device 100 shown in FIG. 4 while avoiding the influence on the signal light that propagates through the parallel waveguides 112g and 112h.

FIG. 10 is a cross-sectional view of the optical waveguide device 100-1 corresponding to the cross-sectional view of the optical waveguide device 100 shown in FIG. 6, which is taken along the line VI-VI.

The optical waveguide device 100-1 shown in FIG. 10 has the same configuration as the configuration of the optical waveguide device 100 shown in FIG. 6, but the thickness of the substrate 102 in the portion shown in the drawing is smaller than the thickness of the substrate 102 shown in FIG. 6. The thickness of the substrate 102 in the portion shown in the drawing may be formed, for example, to be the same as the thickness of the slab portion 145 formed in other portions of the substrate 102. The oxygen-deficient layer 200 is formed on the upper surface of the substrate 102.

Accordingly, in the optical waveguide device 100-1 shown in FIG. 10, the unnecessary light that propagates through the portion shown in the drawing can be more effectively removed than in the optical waveguide device 100 shown in FIG. 6.

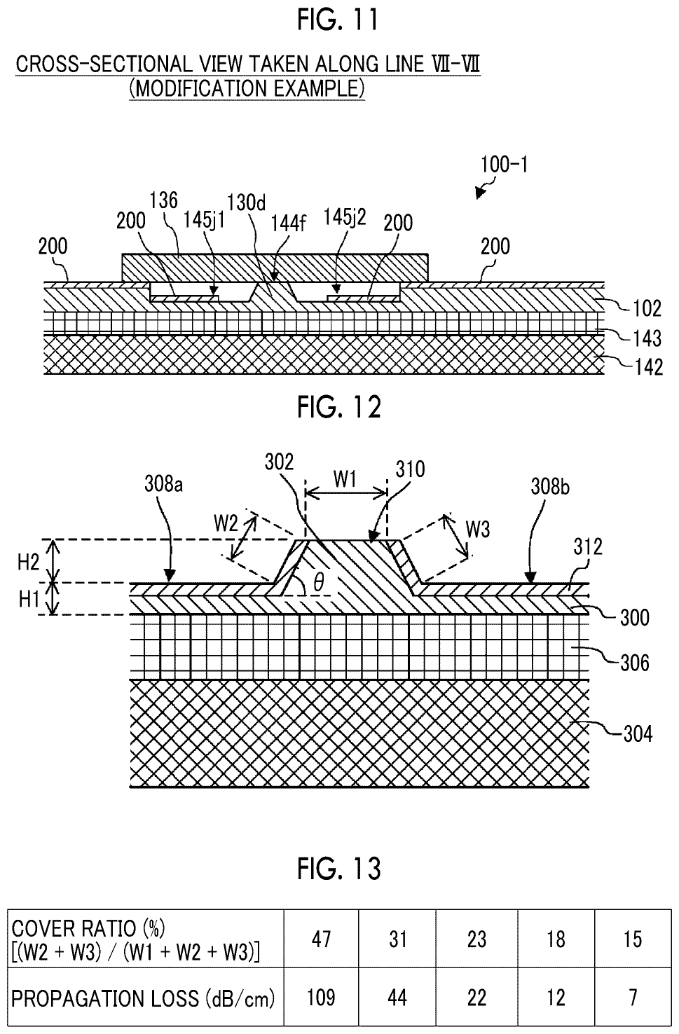

FIG. 11 is a cross-sectional view of the optical waveguide device 100-1 corresponding to the cross-sectional view of the optical waveguide device 100 shown in FIG. 7, which is taken along the line VII-VII.

The optical waveguide device 100-1 shown in FIG. 11 has the same configuration as the configuration of the optical waveguide device 100 shown in FIG. 7, but the portions of the substrate 102 that interpose the rib portion 144f of the radiated light beam waveguide 130d are slab portions 145j1 and 145j2 having a larger width instead of the slab portions 145f1 and 145f2.

The oxygen-deficient layer 200 is formed spaced away from the rib portion 144f, on each of the upper surfaces of the slab portions 145j1 and 145j2. As a result, in the optical waveguide device 100-1 shown in FIG. 11, the unnecessary light leaking into the substrate 102 can be more effectively removed than in the optical waveguide device 100 shown in FIG. 7 without affecting the loss in the light that propagates through the radiated light beam waveguide 130d, and thus without affecting the monitor light quantity received by the light-receiving element 136.

As described above, in a case where the oxygen-deficient layer 200 is disposed on the upper surface and/or the side surface of the radiated light beam waveguide 130, the effect of unnecessary light removal can be obtained even in a case where the oxygen-deficient layer 200 is formed on only a part of the upper surface or the side surface. In this case, a difference in the effect of unnecessary light removal may occur depending on a width of a range of the upper surface and the side surface of the radiated light beam waveguide 130 in which the oxygen-deficient layer 200 is formed.

Therefore, as the evaluation of the light attenuation effect of the oxygen-deficient layer, a relationship between a formation range of the oxygen-deficient layer on the surface of the rib portion and a propagation loss in the light that propagates through the rib portion was evaluated. FIGS. 12 and 13 are views showing the evaluation. FIG. 12 is a cross-sectional view of a rib optical waveguide used for the evaluation. An evaluation sample is a rib optical waveguide 302 formed on a substrate 300 that is the same LN substrate as the substrate 102. The substrate 300 is fixed to a supporting plate 304 that is the same as the supporting plate 142 via an adhesive layer 306 that is the same as the adhesive layer 143.

The optical waveguide 302 includes a rib portion 310 interposed between slab portions 308a and 308b. Hereinafter, the slab portions 308a and 308b are also collectively referred to as a slab portion 308.

An oxygen-deficient layer 312 formed by surface treatment via dry etching as in the oxygen-deficient layer 200 is formed on both side surfaces of the rib portion 310 and on the slab portions 308a and 308b. However, an upper surface of the rib portion 310 is protected by a mask material, and thus the oxygen-deficient layer 312 is not formed.

The evaluation was performed by measuring a waveguide loss of a plurality of evaluation samples, each having a different width W1 of the upper side of a trapezoidal cross section of the rib portion 310. In FIG. 12, a thickness H1 of the substrate 300 of the slab portion 308 and a height H2 of the rib portion 310 measured from the upper surface of the slab portion 308 satisfy H1≈H2. In addition, the lengths of both lateral sides of the rib portion 310 are denoted by W2 and W3.

FIG. 13 is a table showing the evaluation results. A first row of the table shown in the drawing shows a cover ratio, which is a ratio of lengths (W2+W3) of the sides of the portion in which the oxygen-deficient layer is formed to the sum of the lengths of the upper side and both lateral sides of the rib portion (W1+W2+W3). The widths of W1, W2, and W3 were measured by SEM measurement. A second row shows an optical propagation loss in the rib portion 310.

From the table shown in FIG. 13, it can be seen that the optical propagation loss sharply increases at a cover ratio of 31% or more. That is, from the viewpoint of effectively removing the unnecessary light in the optical waveguide through which the unnecessary light propagates, such as the radiated light beam waveguide including the rib optical waveguide, the ratio of the sum of the lengths of the sides of the trapezoidal shape on which the oxygen-deficient layer is formed to the sum of the lengths of the sides of the trapezoidal cross section formed by the rib portion is preferably 18% or more, more preferably 23% or more, and still more preferably 31% or more.

### Second Embodiment

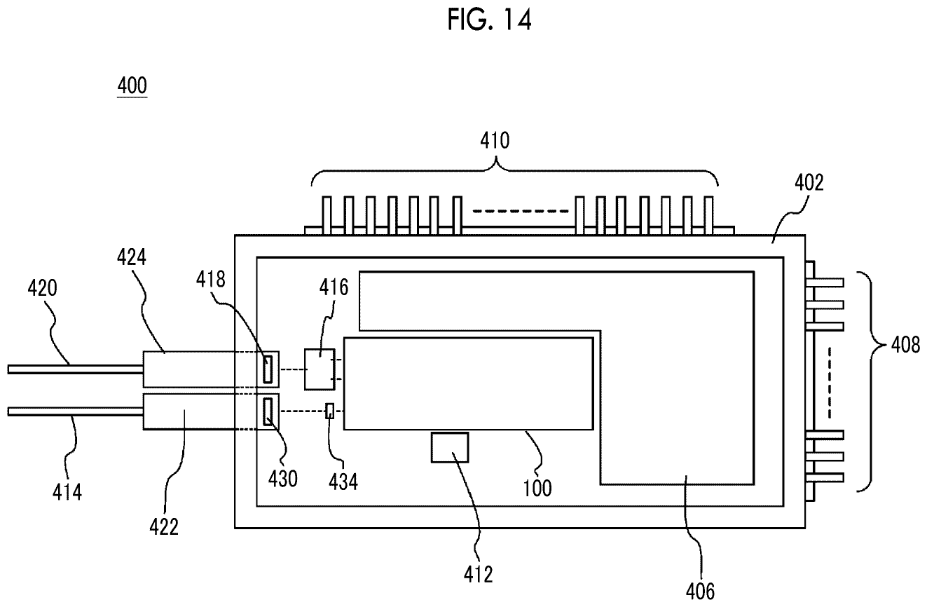

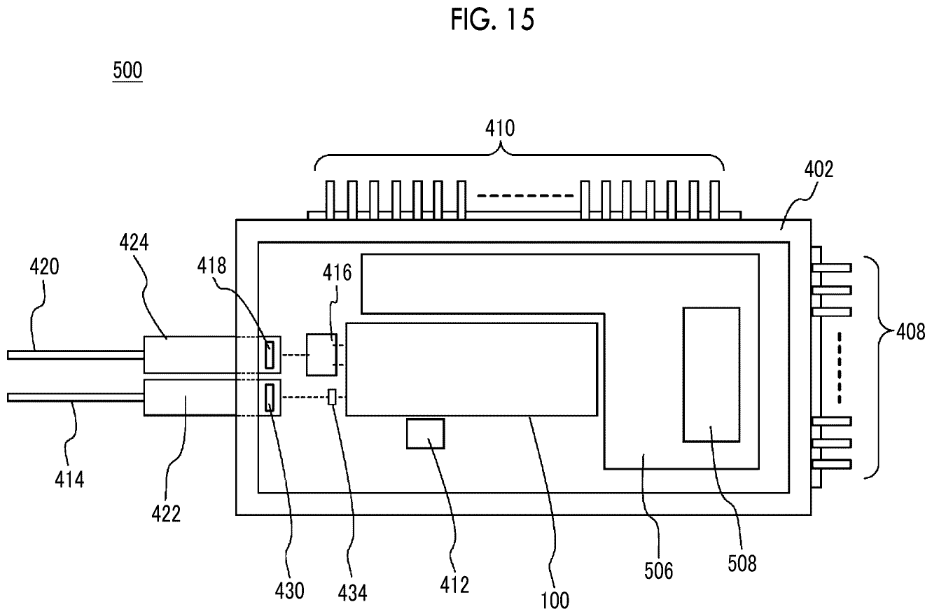

Hereinafter, a second embodiment of the present invention will be described. The present embodiment is an optical modulator using the optical waveguide device 100. FIG. 14 is a diagram showing a configuration of an optical modulator 400 according to the second embodiment. The optical modulator 400 includes a case 402, an optical waveguide device 100 accommodated in the case 402, and a relay substrate 406. Finally, a cover (not shown), which is a plate body, is fixed to an opening portion of the case 402, and the inside of the case 402 is airtightly sealed.

The optical modulator 400 further includes a signal pin 408 for inputting the high-frequency electrical signal used for the modulation of the optical waveguide device 100 and a signal pin 410 for inputting the electrical signal used for adjusting an operating point of the optical waveguide device 100.

Further, the optical modulator 400 includes an input optical fiber 414 for inputting the light into the case 402 and an output optical fiber 420 for guiding the light modulated by the optical waveguide device 100 to the outside of the case 402, on the same surface of the case 402 (in the present embodiment, a left surface in the drawing).

Here, the input optical fiber 414 and the output optical fiber 420 are fixed to the case 402 via supports 422 and 424 as fixing members, respectively. The light input from the input optical fiber 414 is collimated by the lens 430 disposed in the support 422, and then input to the optical waveguide device 100 via the lens 434. However, this is merely an example, and the light can be input to the optical waveguide device 100, based on the related art, for example, by introducing the input optical fiber 414 into the case 402 via the support 422, and connecting an end surface of the introduced input optical fiber 414 to an end surface of the substrate 102 of the optical waveguide device 100.

The light output from the optical waveguide device 100 is coupled to the output optical fiber 420 via the optical unit 416 and the lens 418 disposed on the support 424. The optical unit 416 may include a polarization beam combiner that combines two modulated light output from the optical waveguide device 100 into a single beam.

The relay substrate 406 relays the high-frequency electrical signal input from the signal pin 408 and the electrical signal for adjusting the operating point (bias point) input from the signal pin 410 to the optical waveguide device 100, according to a conductor pattern (not shown) formed on the relay substrate 406. For example, the conductor pattern on the relay substrate 406 is connected to one end of the wiring electrode 118 of the optical waveguide device 100 by wire bonding or the like. Further, the optical modulator 400 includes a terminator 412 having a predetermined impedance in the case 402.

Since the optical modulator 400 having the above-described configuration uses the optical waveguide device 100 according to the first embodiment, the modulation operation can be realized in which the characteristic variation such as DC drift caused by the stress accumulation in the substrate is more suppressed, and better optical characteristics such as the extinction ratio is obtained by effectively removing the unnecessary light than in the related art.

### Third Embodiment

Hereinafter, a third embodiment of the present invention will be described. The present embodiment is an optical modulation module 500 using the optical waveguide device 100 according to the first embodiment. FIG. 15 is a diagram showing the configuration of the optical modulation module 500 according to the present embodiment. In FIG. 15, the same components as the components of the optical modulator 400 according to the second embodiment shown in FIG. 14 are denoted by the same reference numerals as the reference numerals shown in FIG. 14, and the description of FIG. 14 is incorporated herein by reference.

The optical modulation module 500 has the same configuration as the optical modulator 400 shown in FIG. 14, but is different from the optical modulator 400 in that the optical modulation module 500 includes a circuit substrate 506 instead of the relay substrate 406. The circuit substrate 506 includes a drive circuit 508. The drive circuit 508 generates the high-frequency electrical signal for driving the optical waveguide device 100 based on, for example, the modulation signal supplied from the outside via the signal pin 408, and outputs the generated high-frequency electrical signal to the optical waveguide device 100.

Since the optical modulation module 500 having the above-described configuration uses the optical waveguide device 100 according to the first embodiment, the modulation operation can be realized in which the characteristic variation such as DC drift caused by the stress accumulation in the substrate is more suppressed, and better optical characteristics such as the extinction ratio is obtained by effectively removing the unnecessary light than in the related art.

### Fourth Embodiment

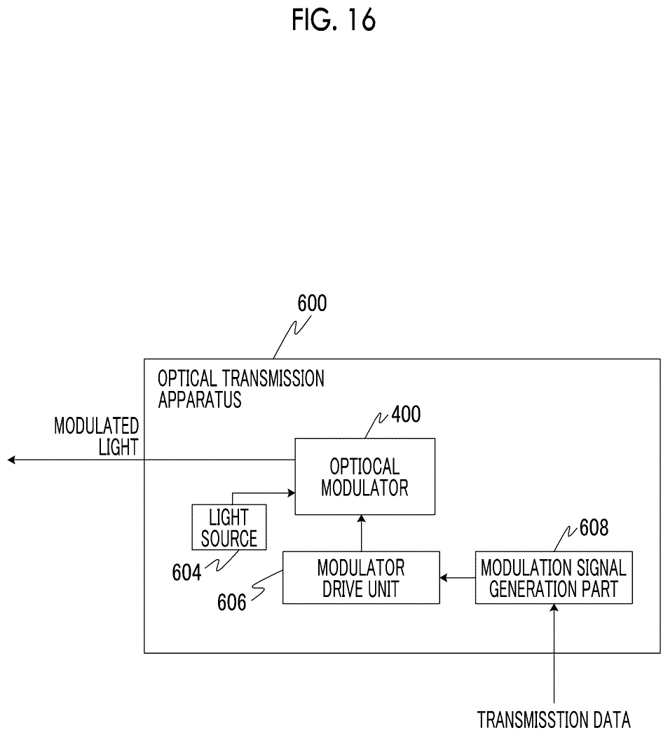

Hereinafter, a fourth embodiment of the present invention will be described. The present embodiment is an optical transmission apparatus 600 equipped with the optical modulator 400 according to the second embodiment. FIG. 16 is a view showing a configuration of the optical transmission apparatus 600 according to the present embodiment. The optical transmission apparatus 600 includes the optical modulator 400, a light source 604 that inputs the light to the optical modulator 400, a modulator drive unit 606, and a modulation signal generation part 608. The optical modulation module 500 can also be used instead of the optical modulator 400 and the modulator drive unit 606.

The modulation signal generation part 608 is an electronic circuit that generates an electrical signal for causing the optical modulator 400 to perform a modulation operation, and the modulation signal generation part 608 generates, based on transmission data given from the outside, the modulation signal as the high-frequency signal for causing the optical modulator 400 to perform the optical modulation operation corresponding to the modulation data, and outputs the generated modulation signal to the modulator drive unit 606.

The modulator drive unit 606 amplifies the modulation signal input from the modulation signal generation part 608, and outputs the high-frequency electrical signal for driving the signal electrode of the optical waveguide device 100 included in the optical modulator 400. As described above, for example, the optical modulation module 500 provided with the drive circuit 508 including a circuit corresponding to the modulator drive unit 606 inside the case 402 can also be used instead of the optical modulator 400 and the modulator drive unit 606.

The high-frequency electrical signal is input to the signal pin 408 of the optical modulator 400 to drive the optical waveguide device 100. Therefore, the light output from the light source 604 is modulated by the optical modulator 400 to become modulated light, and is output from the optical transmission apparatus 600.

The optical transmission apparatus 600 having the above-described configuration uses the optical waveguide device 100. Therefore, as in the optical modulator 400 according to the second embodiment and the optical modulation module 500 according to the third embodiment, good optical transmission can be realized by realizing the modulation operation in which the characteristic variation such as DC drift caused by the stress accumulation in the substrate is more suppressed, and better optical characteristics such as the extinction ratio is obtained by effectively removing the unnecessary light than in the related art.

### SUMMARY

The present invention is not limited to the configurations of the above-described embodiments, and can be implemented in various embodiments without departing from the gist of the present invention.

In the above-described embodiments, the rib portions 144 and 310 constituting the optical waveguide have a trapezoidal cross section, but the rib portions 144 and 310 may have a cross section having a shape that can propagate light, such as a trapezoidal shape, a square shape, or a rectangular shape.

The means for forming the oxygen-deficient layer is a dry etching treatment in the above-described embodiments, but the means is not limited to this, and a known method can be used.

In addition, the substrate 102 is made of LN in the above-described embodiments, but is not limited to LN and may be made of any oxide. For example, the substrate 102 may be made of LiTaO_{3,} BaTiO₃, or KTa₁₋ₓNbₓO₃.

Further, another structure may be disposed on the principal surface of the substrate 102 on which the oxygen-deficient layer 200 is formed. For example, another supporting plate can be disposed on the substrate 102 via the adhesive layer. In this case, the “surface layer of the principal surface of the substrate made of the oxide” refers to a surface layer of the principal surface of the substrate 102, and does not mean a surface of the other structure that is disposed on the principal surface and that is in contact with the outside air.

As described above, an optical waveguide device 100 that is an optical waveguide device according to the first embodiment includes: a substrate 102 made of LN as an oxide; and an optical waveguide 104 formed on a principal surface of the substrate 102. The substrate 102 includes an oxygen-deficient layer 200 having a lower oxygen content than in other portions of the substrate 102. The oxygen-deficient layer 200 is disposed in a region, on the principal surface of the substrate 102, other than a waveguide path for light from an optical input end 170 to an optical output end 172 of the optical waveguide 104.

With this configuration, as compared with the related-art configuration in which a metal film such as Ti is formed on the substrate, the unnecessary light that propagates through the substrate 102 can be effectively attenuated and removed while suppressing the generation of the stress in the substrate 102.

Further, the oxygen-deficient layer 200 is disposed in a surface layer of the principal surface of the substrate 102.

With this configuration, for example, the oxygen-deficient layer 200 can be easily formed by the surface treatment of the substrate 102 using the dry etching.

Further, the optical waveguide 104 is a rib optical waveguide including a rib portion 144 as a protruding portion of the substrate 102, which extends on the principal surface of the substrate 102, and a slab portion 145 having a smaller thickness of the substrate 102 than in the rib portion 144, and the oxygen-deficient layer 200 is disposed on a side surface and/or an upper surface of the rib portion 144 in the optical waveguide 104 other than the waveguide path for light from the optical input end 170 to the optical output end 172 of the optical waveguide 104.

With this configuration, for example, the unnecessary light can be attenuated in the radiated light beam waveguide 130 through which the unnecessary light propagates.

Further, in a cross section of the rib portion 144 perpendicular to a length direction of the optical waveguide 104, a ratio of a sum of lengths of an upper side and two lateral sides of the cross section of the rib portion 144 to a sum of lengths of the upper side and/or the lateral sides on which the oxygen-deficient layer 200 is formed is 18% or more.

With this configuration, for example, the unnecessary light can be effectively attenuated in the radiated light beam waveguide 130 through which the unnecessary light propagates.

Further, the oxygen-deficient layer 200 is disposed on an upper surface of the slab portion 145.

With this configuration, the unnecessary light that propagates through the portion of the substrate 102 on which the slab portion 145 is formed can be effectively attenuated and removed.

Further, the substrate 102 has a thickness of 2 μm or less.

With this configuration, the effect of effectively removing the unnecessary light via the oxygen-deficient layer 200 can be exhibited.

Further, the substrate 102 has an electro-optic effect.

Further, an optical modulator 400 according to the second embodiment includes: the optical waveguide device 100 performing optical modulation; a case 402 that accommodates the optical waveguide device 100; an input optical fiber 414 through which light is input to the optical waveguide device 100; and an output optical fiber 420 that guides the light output by the optical waveguide device 100 to an outside of the case 402.

Further, an optical modulation module 500 according to the third embodiment includes: the optical waveguide device 100; a case 402 that accommodates the optical waveguide device 100; an input optical fiber 414 through which light is input to the optical waveguide device 100; an output optical fiber 420 that guides the light output by the optical waveguide device 100 to an outside of the case 402; and a drive circuit 508 that drives an optical modulation device.

Further, an optical transmission apparatus 600 according to the fourth embodiment includes: the optical modulator 400 according to the second embodiment or the optical modulation module 500 according to the third embodiment; and a modulation signal generation part 608 as an electronic circuit that generates an electrical signal for causing the optical waveguide device 100 to perform a modulation operation.

With to these configurations, it is possible to realize the optical modulator 400, the optical modulation module 500, or the optical transmission apparatus 600 with good optical characteristics and with reduced influence of the unnecessary light.

### REFERENCE SIGNS LIST

100: optical waveguide device
102, 300: substrate
104, 302: optical waveguide
106: input waveguide
108a, 108b: nested Mach-Zehnder optical waveguide
110, 110a, 110b, 110c, 110d: Mach-Zehnder optical waveguide
112, 112a, 112b, 112c, 112d, 112e, 112f, 112g, 112h, 134a, 134b, 134c, 134d: parallel waveguide
114: working electrode
114-1, 114-1a, 114-1b, 114-1c, 114-1d, 114-1e: signal electrode
114-2, 114-2a, 114-2b, 114-2c, 114-2d, 114-2e, 114-2f, 114-2g: ground electrode
118: wiring electrode
118-1, 118-1a, 118-1b, 118-1c, 118-1d, 118-1e, 118-1f, 118-1g, 118-1h: signal wiring electrode
118-2, 118-2a, 118-2b, 118-2c, 118-2d, 118-2e, 118-2f, 118-2g, 118-2h, 118-2i, 118-2j: ground wiring electrode
126a, 126b: output waveguide
128, 128a, 128b, 128c, 128d, 128e, 128f: Y-branch coupler
130, 130a, 130b, 130c, 130d, 130e, 130f, 130g, 130h, 130i, 130j, 130k, 130m: radiated light beam waveguide
132a, 132b, 132c: bias electrode
136: light-receiving element
140a, 140b, 140c, 140d: side
142, 304: supporting plate
143, 306: adhesive layer
144, 144a, 144b, 144c, 144d, 144e, 144f, 310: rib portion
145, 145a1, 145a2, 145b1, 145b2, 145c1, 145c2, 145d1, 145d2, 145e1, 145e2, 145f1, 145f2, 145g1, 145g2, 145h1, 145h2, 145h3, 145j1, 145j2, 308, 308a, 308b: slab portion
146a, 146b: marker
200, 312: oxygen-deficient layer
402: case
406: relay substrate
408, 410: signal pin
412: terminator
414: input optical fiber
416: optical unit
418, 430, 434: lens
420: output optical fiber
422, 424: support
506: circuit substrate
508: drive circuit
600: optical transmission apparatus
604: light source
606: modulator drive unit
608: modulation signal generation part

1. An optical waveguide device comprising:
a substrate made of an oxide; and
an optical waveguide formed on a principal surface of the substrate,
wherein the substrate includes an oxygen-deficient layer having a lower oxygen content than in other portions of the substrate, and
the oxygen-deficient layer is disposed in a region, on the principal surface of the substrate, other than a waveguide path for light from an optical input end to an optical output end of the optical waveguide.

2. The optical waveguide device according to claim 1,
wherein the oxygen-deficient layer is disposed in a surface layer of the principal surface of the substrate.

3. The optical waveguide device according to claim 1,
wherein the optical waveguide is a rib optical waveguide including a rib portion as a protruding portion of the substrate, which extends on the principal surface, and a slab portion having a smaller thickness of the substrate than in the rib portion, and
the oxygen-deficient layer is disposed on a side surface and/or an upper surface of the rib portion in the optical waveguide other than the waveguide path.

4. The optical waveguide device according to claim 3,
wherein, in a cross section of the rib portion perpendicular to a length direction of the optical waveguide, a ratio of a sum of lengths of an upper side and two lateral sides of the cross section of the rib portion to a sum of lengths of the upper side and the lateral sides on which the oxygen-deficient layer is formed is 18% or more.

5. The optical waveguide device according to claim 1,
wherein the optical waveguide is a rib optical waveguide including a rib portion as a protruding portion of the substrate, which extends on the principal surface, and a slab portion having a smaller thickness of the substrate than in the rib portion, and
the oxygen-deficient layer is disposed on an upper surface of the slab portion.

6. The optical waveguide device according to claim 1,
wherein the substrate has a thickness of 2 μm or less.

7. The optical waveguide device according to claim 1,
wherein the substrate has an electro-optic effect.

8. An optical modulator comprising:
the optical waveguide device according to claim 1 as an optical modulation device, including a modulation electrode that modulates a light wave that propagates through the optical waveguide on the principal surface of the substrate and performing optical modulation;
a case that accommodates the optical waveguide device;
an optical fiber through which light is input to the optical waveguide device; and
an optical fiber that guides the light output by the optical waveguide device to an outside of the case.

9. An optical modulation module comprising:
the optical waveguide device according to claim 1 as an optical modulation device, including a modulation electrode that modulates a light wave that propagates through the optical waveguide on the principal surface of the substrate and performing optical modulation;
a case that accommodates the optical waveguide device;
an optical fiber through which light is input to the optical waveguide device;
an optical fiber that guides the light output by the optical waveguide device to an outside of the case; and
a drive circuit that outputs an electrical signal to be input to the modulation electrode.

10. An optical transmission apparatus comprising:
the optical modulator according to claim 8; and
an electronic circuit that generates an electrical signal for causing the optical waveguide device to perform an optical modulation operation.

11. An optical transmission apparatus comprising: the optical modulation module according to claim 9; and
an electronic circuit that generates an electrical signal for causing the optical waveguide device to perform an optical modulation operation.
